(19) United States
(12) Patent Application Publication
(10) Pub. No.: US 2023/0404042 A1
(43) Pub. Date: Dec. 21, 2023

(54) Squirrel Proof Bird Feeder

(71) Applicant: Woodstream Corporation, Lancaster, PA (US)

(72) Inventors: Steven Lorraine, Lancaster, PA (US); Cody Litwiller, Lancaster, PA (US)

(73) Assignee: Woodstream Corporation, Lancaster, PA (US)

(21) Appl. No.: 17/841,068

(22) Filed: Jun. 15, 2022

(51) Int. Cl. A01K 39/01

(52) U.S. Cl. CPC A01K 39/0113

(57) ABSTRACT

A bird feeder comprises an inner housing including a seed reservoir having at least one feed port defined therethrough, and an inner base supporting the seed reservoir. An outer housing of the feeder is moveably mounted to the inner housing, and includes a reservoir cover arranged over the seed reservoir and defining at least one feed opening. The outer housing is moveable relative to the inner housing between a first position and a second position. A tension spring is operatively connected between the inner housing and a base of the outer housing for biasing the outer housing into the first position relative to the inner housing.

### FIELD OF THE INVENTION

The present disclosure relates to bird feeders, and more particularly, to an improved bird feeder which prevents undesired animals from accessing feed retained within the feeder.

### BACKGROUND

Bird feeders are often subject to attack by animals, such as squirrels, attempting to gain access to their stored feed or bird seed. In addition to scaring away would-be feeding birds, squirrels or other animals who gain access to the feeder may consume large amounts of seed. Likewise, attempts to gain access to the seed by these animals often results in excess seed spillage, creating both waste and mess, and risks temporary or permanent damage to the feeder due to their relatively large weight and aggressive nature.

Numerous examples of “squirrel-proof” feeders are found in the prior art. These designs, however, have proven inadequate and/or are overly complicated and thus not cost effective. For example, some feeders utilize moveable covers which selectively close or block feed ports of the feeder in response to excess weight placed on a feeding perch of the feeder. Likewise, other designs utilize complex closing mechanisms which have many parts and occupy excessive space within the feeder and/or lack access for repair or replacement.

Accordingly, there is a need for an improved squirrel or animal proof bird having a simplified design, while remaining cost effective to manufacture and easy to maintain.

### SUMMARY

A bird feeder according to an embodiment of the present disclosure comprises an inner housing including a seed reservoir having at least one feed port defined therethrough providing access to seed contained within the reservoir. The feeder further comprises an outer housing moveably mounted to the inner housing, including a reservoir cover arranged over the seed reservoir and defining at least one feed opening. The outer housing is moveable relative to the inner housing between a first position, wherein the at least one feed port and the at least one feed opening are aligned, and a second position, wherein the at least one feed port and the at least one feed opening are not aligned, and the outer housing covers the feed port. The outer housing further comprises a top cover arranged over and receiving a portion of the inner housing, and an outer base supporting the reservoir cover. A tension spring is operatively connected between the seed reservoir and the outer base for biasing the outer housing into the first position relative to the inner housing, wherein the application of a predetermined force on the outer housing is operative to bias the outer housing into the second position against an elastic return force of the tension spring.

A bird feeder according to another embodiment of the present disclosure comprises an inner housing having a seed reservoir. The seed reservoir defines at least one feed port in communication with an interior of the reservoir holding a quantity of seed. An outer housing is arranged over the inner housing and includes at least one feed opening. The outer housing is moveable relative to the inner housing between a first position, wherein the at least one feed port and the at least one feed opening are aligned, and a second position, wherein the at least one feed port and the at least one feed opening are not aligned. An elastic return assembly is arranged beneath the seed reservoir and biases the outer housing into the first position relative to the inner housing.

### BRIEF DESCRIPTION OF THE DRAWINGS

The invention will now be described by way of example with reference to the accompanying figures, of which:

FIG. 1A is a perspective view of a bird feeder according to an embodiment of the present disclosure in a first or open state;

FIG. 1B is a first front view of the bird feeder of FIG. 1A;

FIG. 2A is a perspective view of the bird feeder in a second or closed;

FIG. 2B is a first front view of the bird feeder of FIG. 2A;

FIG. 3 is a cross-sectional view of a first side of the bird feeder in the open state;

FIG. 4 is a cross-sectional view of a second side of the bird feeder in the open state;

FIG. 5 is a cross-sectional view of the first side of the bird feeder in the closed state;

FIG. 6 is a cross-sectional view of the second side of the bird feeder in the closed state;

FIG. 7 is a top view of the bird feeder; and

FIG. 8 is a bottom view of the bird feeder.

### DETAILED DESCRIPTION OF THE EMBODIMENT(S)

Exemplary embodiments of the invention will be described hereinafter in detail with reference to the attached drawings, wherein like reference numerals refer to like elements. The invention may, however, be embodied in many different forms and should not be construed as being limited to the embodiments set forth herein; rather, these embodiments are provided so that the present disclosure will be thorough and complete, and will fully convey the concept of the disclosure to those skilled in the art.

Embodiments of the present disclosure include a feeder, such as a bird feeder, adapted to resist attacks from all angles, including from the sides, top and/or bottom of the feeder. The feeder includes an inner housing and an outer housing moveably mounted to the inner housing. The inner housing defines a seed reservoir having at least one feed port therethrough for providing access to the seed, an inner base arranged on a bottom of the seed reservoir and a top cover arranged over the top of the inner housing. The outer housing includes a reservoir cover arranged generally around the inner housing, and an outer base attached to a bottom of the reservoir cover. The reservoir cover includes feed openings corresponding to the feed ports of the seed reservoir. The outer housing, including the reservoir cover and the outer base, is moveable relative to the inner housing between a first or open position, wherein the feed openings and feed ports are aligned, and a second or closed position, wherein the feed openings and feed ports are not aligned and the outer housing covers the feed ports. In this way, in response to the application of a predetermined force placed on any portion of the outer housing, the feeder is biased into the closed position or state.

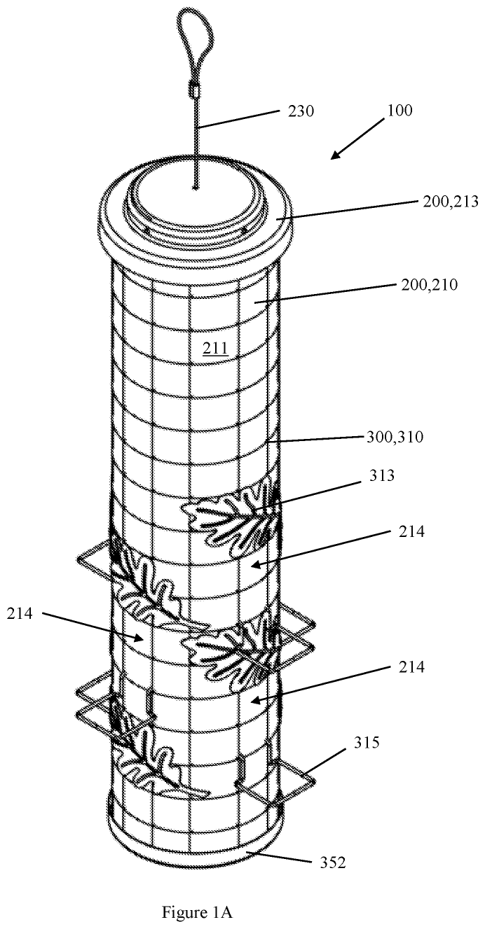

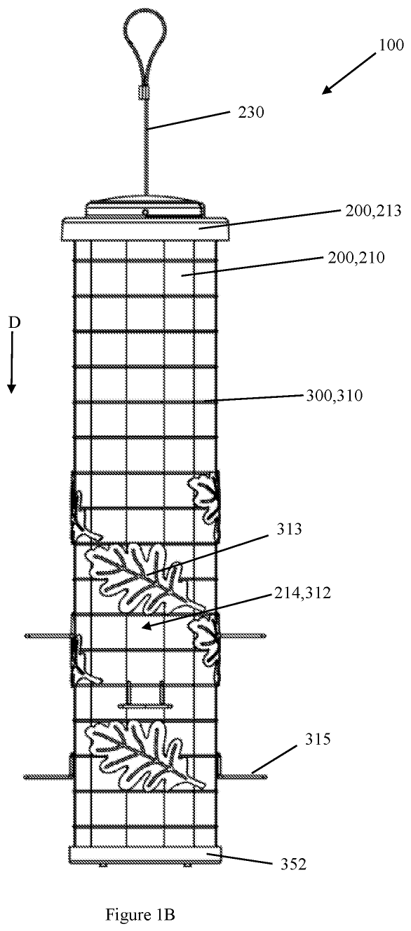

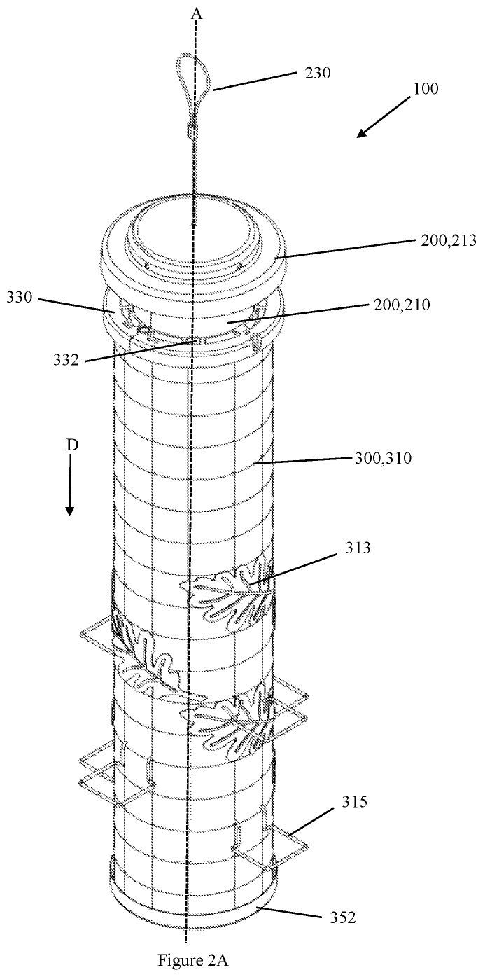

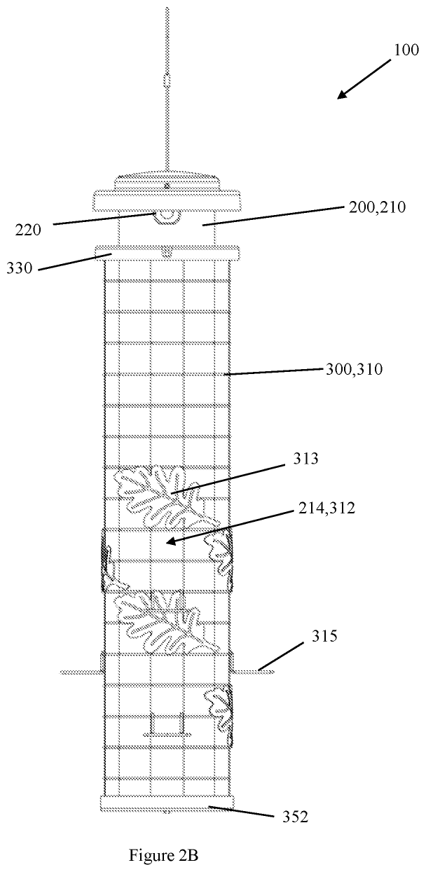

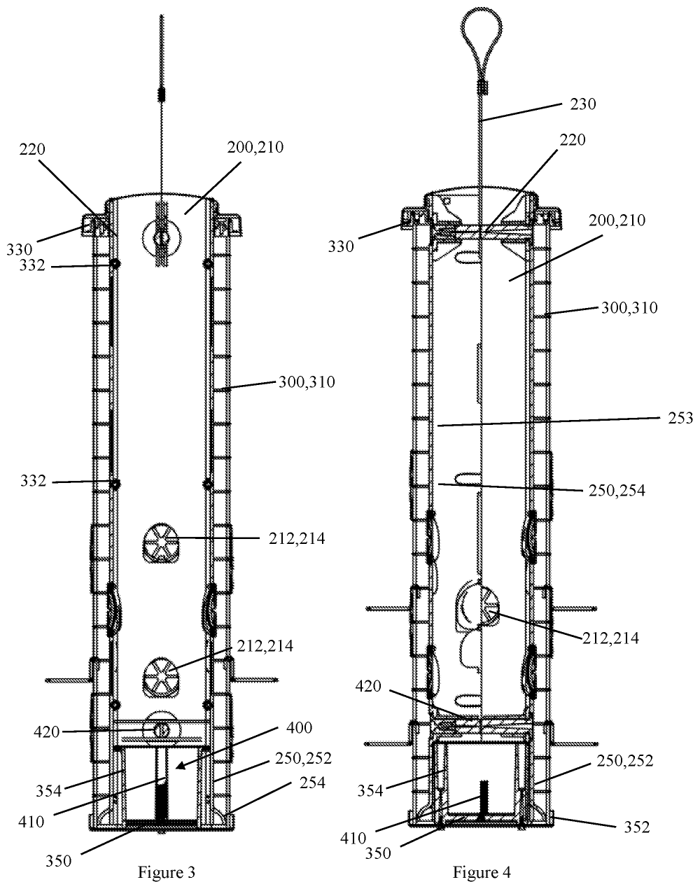

Referring to FIGS. 1A-2B, a feeder 100 according to an embodiment of the present disclosure is shown in an open or feeding position or state, wherein one or more feed ports 214 (see FIGS. 3 and 4) are exposed, providing access to feed held within the feeder. More specifically, the feeder 100 includes a fixed subassembly or inner housing 200 and a moveable subassembly or outer housing 300 arranged in a telescoping manner over the inner housing. The inner housing 200 includes a hollow intermediate section or seed reservoir 210 defining a seed space 211, a feeder top cover or lid 213 fixedly attached to the seed reservoir, a feeder support 220 arranged proximate a first end of the seed reservoir, and an inner base or bottom end 250 (see FIGS. 3-6) fitted to a second end of the seed reservoir, opposite the first end. The feeder 100 further comprises a hanging wire 230 including an end fixable to the feeder support 220, and a free end attachable to an external support structure, for hanging the feeder by the inner housing 200. The inner housing 200 defines a subassembly in that, with the feeder 100 suspended via the wire 230, is generally fixed in position with respect to the wire under the force of gravity. In response to an animal acting on a surface thereof, however, the outer housing 300 is moveable relative to the inner housing 200.

The moveable subassembly or outer housing 300 includes an intermediate portion or reservoir cover 310, a support guide or upper cap 330, and an outer base or bottom end 350 fixed to the reservoir cover and sized to be moveably received within an underside of the inner base 250. See FIGS. 3-6. The outer housing 300 is moveable relative to the inner housing 200 in the indicated direction D from the open position of the feeder 100 illustrated in FIGS. 1A, 1B, 3 and 4, to the closed position illustrated in FIGS. 2A, 2B, 5 and 6, wherein the reservoir cover 310 blocks the feed ports 214, preventing access to the seed space 211 therethrough. As shown in FIG. 2A, the outer housing 300 is moveable relative to the inner housing 200 along a vertical axis A, which may be a central axis of the feeder 100.

As will be set forth in greater detail herein, the outer housing 300 is held in the open position via the application of a force generated by an elastic biasing arrangement or assembly 400. In response to the application of a sufficient opposite force on any portion of the outer housing 300, including feeding pedestals 315 of the reservoir cover 310, the outer housing is biased downward, against the return force of an elastic element of the biasing assembly 400. In this way, in response to an animal attack on an exterior surface of the feeder, the outer housing 300 of the feeder will be biased into the closed position, blocking access to the seed held within the seed space 211. Likewise, when the biasing force is removed (e.g., when an animal releases or dismounts the feeder), the outer housing 300 will return to the open position under a return force applied by the elastic element, wherein the feed port(s) 214 are exposed and normal feeding can be resumed.

The exemplary seed reservoir 210 comprises a hollow cylindrical housing, such as a transparent polymer housing, and defines the feed space 211 for holding a volume of feed, such as bird seed. The reservoir 210 comprises one or more openings 212 formed therethrough. The openings 212 may be fitted with, or covered by, the feed ports 214. The feed ports 214 include, for example, flexible fingers for preventing seed from falling out of the reservoir 210, while permitting a feeding bird to access the seed therethrough.

The reservoir cover 310 may comprise a generally cylindrical wire mesh shield defined by a plurality of horizontally and vertically extending wire segments. The reservoir cover 310, and more specifically, the mesh pattern thereof, defines openings 312 adapted to align with the feed ports 214 and openings 212 of the seed reservoir 210 in the first position of the feeder 100. The reservoir cover 310 further defines blocking sections or port covers 313, embodied as camouflaging and/or decorative elements (e.g., leaves), positioned over the mesh for covering the feed ports 214 in the second position of the feeder 100. The feeding perches 315 may be fixed or otherwise attached to the reservoir cover 310, and provide resting surfaces for birds while feeding. In one embodiment, each perch 315 is hingedly attached to the reservoir cover 310.

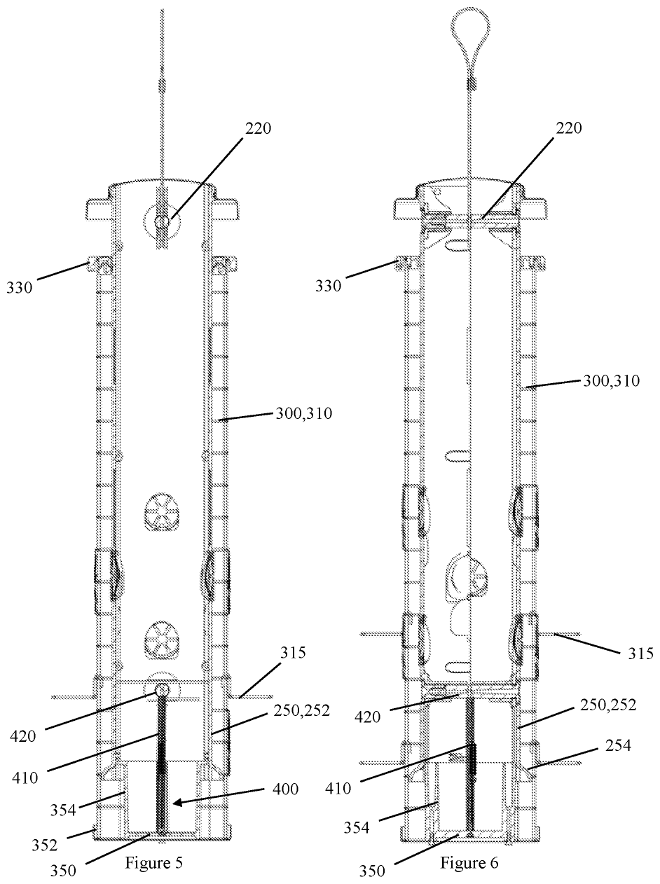

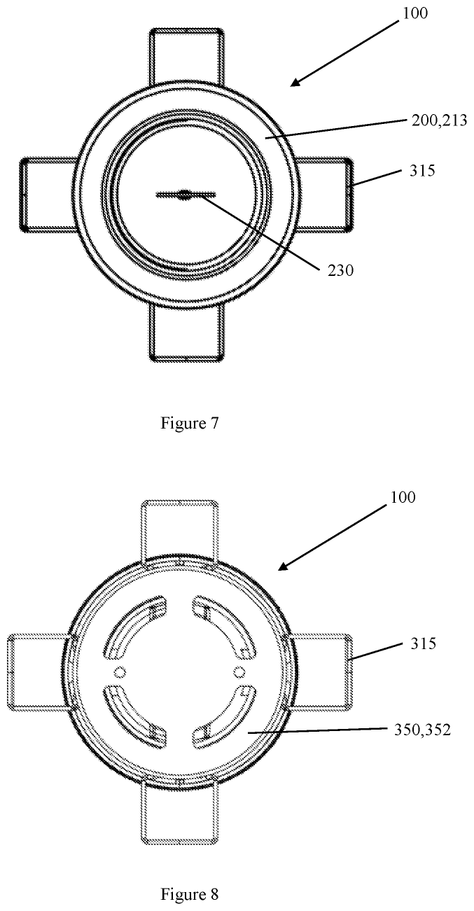

The reservoir cover 310 is fixedly attached to the support guide 330. In one embodiment, the support guide 330 is sized to slidably engage with the exterior surface of the seed reservoir 210 for maintaining the coaxial relationship therebetween. In other embodiments, the support guide 330 may include a plurality of roller bearings 332 (see FIG. 2A) arranged radially about an interior opening thereof. The bearings 332 are adapted to rotatably or slidably engage with the exterior surface of the seed reservoir 210 received within the interior opening. In this way, the support guide 330 acts to guide the axial or telescoping movement of the reservoir cover 310 over seed reservoir 210 between the first and second positions of the feeder. In still other embodiments, bearings or rollers 332 may be arranged at other locations, but generally between the outer housing 300 and the inner housing 200, as shown in FIGS. 3 and 5. These arrangements ensure the outer housing 300 remains centered relative to the inner housing 200, despite potentially high and axially offset forces acting therein by an attacking animal. The feeder support 220 is fixed to a first or top end of the seed reservoir 210 and defines an attachment element (e.g., a mounting hole) for receiving an end of the hanging wire 230. In other embodiments, the feeder support comprises a transversely extending pin about which the hanging wire is wrapped or otherwise affixed. In some embodiments, the feeder support is removable from a remainder of the inner housing 200.

The inner base 250 may be fitted to a lower end of the seed reservoir 210, or formed integrally therewith, and generally comprises an outer flange 252, and a first cylindrical body portion 254 sized for fixed insertion within the seed reservoir 210. The inner base 250, including the cylindrical body 254, is generally hollow in nature and configured to slidably receive the second or outer base 350 therein in an assembled state of the feeder 100.

Similar to the inner base 250, the outer base 350 includes a base plate or mounting flange 352, which may be formed integrally with or attached to the reservoir cover 310, and a hollow cylindrical body 354. The body 354 may be fixed to the mounting flange 352 via fasteners, and is sized to be slidably received within the hollow interior of the inner base 250, as shown in FIGS. 3-6. The annular base plate 352 defines a flange extending in the longitudinal direction of the feeder 100 for capturing a free end of the reservoir cover 310. The base plate 352, or the body 354, acts as a mechanical stop, opposing the inner base 250 and limiting relative motion therebetween motion along the axis A under the return force of the biasing assembly 400. According to embodiments of the present disclosure, at least one of the inner housing 200 and the outer housing 300 may further define a mechanical stop for limiting relative motion between the housings 200,300 in response to a force acting thereon by an animal. As can be visualized from the figures, the telescoping arrangement of the respective bases 250,350 provides a locating function between the inner and outer housings 200,300, supporting and guiding their respective movement along the axis A while maintaining their coaxial alignment. In some embodiments, complementary engaging anti-rotation features (e.g., protrusions and corresponding channels or recesses), may be formed in the inner and outer bases 250,350 for maintaining radial alignment of the inner and outer housings 200,300 as the feeder 100 is moved from the second position to the first position.

Referring to FIGS. 3 and 4, and FIGS. 5 and 6, the outer housing 300 and the inner housing 200 are shown in the first and second positions, respectively. The biasing assembly 400 includes an elastic member, such as a tension spring 410 (e.g., a coil tension spring) arranged between and connected to the inner housing 200 and the outer housing 300 for biasing the outer housing into the first position relative to the inner housing. The tension spring 410 is arranged within a spring space defined by the inner and outer bases 250,350. The biasing assembly 400 is arranged below a floor of the seed reservoir 210, and therefore does not limit its capacity, unlike arrangements of the prior art which include springs intruding or through the seed reservoir or seed space.

As shown in the figures, the application of a predetermined force on the outer housing 300 is operative to bias the outer housing into the second position against an elastic return force of the spring 410. In the exemplary embodiment, the tension spring 410 includes a first end attached to the outer base 350. The inner housing 200 defines a spring mount 420, or mounting structure fixedly attached to the seed reservoir. A second end of the tension spring 410 is attached to the mount 420. In one embodiment, the mount 420 is formed integrally with the inner base 250, and extends horizontally through the internal cavity defined thereby. In other embodiments, the mount 420 comprises a pin or rod-like structure extending between and supported by the inner base 250. The mount 420 may be removable from the inner base. Specifically, the mount may be inserted into the inner base 250 and through an opening or eye of an end of the spring 410 for securing the spring thereto. It should be understood that any suitable attachment means (e.g., fasteners, etc.) may be used to fix the spring to both the inner and outer bases 250,350.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range.

Also, the indefinite articles “a” and “an” preceding an element or component of the invention are intended to be nonrestrictive regarding the number of instances, that is, occurrences of the element or component. Therefore “a” or “an” should be read to include one or at least one, and the singular word form of the element or component also includes the plural unless the number is obviously meant to be singular.

The term “invention” or “present invention” as used herein is a non-limiting term and is not intended to refer to any single embodiment of the particular invention but encompasses all possible embodiments as described in the application.

What is claimed is:

1. A bird feeder comprising:
an inner housing, including a seed reservoir having at least one feed port defined therethrough for providing access to seed contained within the seed reservoir;
an outer housing moveably mounted to the inner housing and including a reservoir cover arranged over the seed reservoir and defining at least one feed opening, the outer housing moveable relative to the inner housing along a central axis of the feeder between a first position, wherein the at least one feed port and the at least one feed opening are aligned, and a second position, wherein the at least one feed port and the at least one feed opening are not aligned and the outer housing covers the feed port; and
a tension spring operatively connected to the inner housing and the outer housing for biasing the outer housing into the first position relative to the inner housing, wherein the application of a predetermined force on the outer housing is operative to bias the outer housing into the second position against an elastic return force of the compression spring.

2. The bird feeder of claim 1, wherein the outer housing is moveable in a telescoping manner over the inner housing.

3. The bird feeder of claim 2, wherein the outer housing further includes a support guide including at least one roller bearing engaged with a surface of the inner housing for maintaining alignment of the outer housing relative to the inner housing as the outer housing moves between the first and second positions.

4. The bird feeder of claim 1, wherein the inner housing further comprises an inner base arranged on an end of the seed reservoir, and the outer housing further comprises an outer base supporting the reservoir cover.

5. The bird feeder of claim 4, wherein the inner base and the outer base abut one another in an axial direction in the first position.

6. The bird feeder of claim 4, wherein the tension spring includes a first end attached to the outer base.

7. The bird feeder of claim 6, wherein the inner housing includes a mount fixedly attached to the seed reservoir, a second end of the tension spring attached to the mount.

8. The bird feeder of claim 7, wherein the mount extends horizontally through at least one wall of the seed reservoir.

9. The bird feeder of claim 4, wherein the inner base receives at least a portion of the outer base in the first position of the outer housing.

10. The bird feeder of claim 9, wherein the inner base and the outer base comprise complementary guides for maintaining an alignment between the outer housing and the inner housing between the first and second positions.

11. The bird feeder of claim 4, wherein the tension spring is arranged within a spring space defined by the outer base.

12. The bird feeder of claim 1, wherein the tension spring extends along the central axis of the feeder.

13. The bird feeder of claim 1, wherein the inner housing includes a feeder support fixedly attached to the seed reservoir for suspending the feeder in a substantially vertical orientation.

14. The bird feeder of claim 1, further comprising a top cover arranged over and receiving a portion of the inner housing.

15. The bird feeder of claim 1, wherein the reservoir cover comprises a wire frame defining a plurality of openings.

16. A bird feeder comprising:
an inner housing having a seed reservoir and at least one feed port for accessing an interior of the seed reservoir;
an outer housing arranged over the inner housing and including at least one feed opening, the outer housing moveable relative to the inner housing between a first position, wherein the at least one feed port and the at least one feed opening are aligned, and a second position, wherein the at least one feed port and the at least one feed opening are not aligned; and
an elastic return assembly arranged below the seed reservoir and biasing the outer housing into the first position relative to the inner housing.

17. The bird feeder of claim 16, wherein outer housing includes a reservoir cover supported on an outer base, the elastic return assembly includes a tension spring arranged below a floor of the seed reservoir and attached between the seed reservoir and the outer base, the tension spring biasing the outer housing in an upward direction and into the first position relative to the inner housing, wherein the application of a predetermined force on the outer housing biases the outer housing into the second position against an elastic return force of the tension spring.

18. The bird feeder of claim 17, wherein the inner housing includes a spring mount extending through the seed reservoir in a horizontal direction, the tension spring arranged between the spring mount and a side of the outer base opposing the seed reservoir.

19. The bird feeder of claim 17, wherein the inner housing includes an inner base arranged on an end of the seed reservoir, the inner base and the outer base comprise complementary guides for maintaining an alignment between the outer housing and the inner housing between the first and second positions.

20. The bird feeder of claim 16, wherein the outer housing further includes a support guide including at least bearing surface engaged with a surface of the inner housing for maintaining alignment of the outer housing relative to the inner housing as the outer housing moves between the first and second positions.
